(19) United States
(12) Patent Application Publication
(10) Pub. No.: US 2008/0297538 A1
(43) Pub. Date: Dec. 4, 2008

(54) APPARATUS AND METHOD FOR SETTING A COMMON VOLTAGE

(75) Inventors: Man-Seung Cho, Seoul (KR); Joo-Hyung Lee, Gwacheon-si (KR); Bo-Young An, Suwon-si (KR); Seung-Bin Moon, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD, Suwon-si (KR)

(21) Appl. No.: 12/129,870

(22) Filed: May 30, 2008

(30) Foreign Application Priority Data
May 31, 2007 (KR) 10-2007-0053372

(51) Int. Cl. G09G 5/10

(52) U.S. Cl. 345/690

(57) ABSTRACT

An apparatus for setting a common voltage include a screen generator, a flicker measuring part, a main controller and a read-only memory (“ROM”) programming part. The screen generator generates image data of a test screen. The flicker measuring part measures flicker on the test screen displayed on a display panel to which a common voltage corresponding to an estimated setting value is applied. The main controller calculates a measured flicker index from the measured flicker and compares the measured flicker index with a predetermined threshold value to determine a setting value corresponding to a flicker index of a plurality of calculated flicker indexes that is less than the threshold value. The ROM programming part writes the determined setting value to a ROM of a display module. Therefore, a common voltage is reestablished by the setting value, thus preventing flicker due to process variations.

This application claims priority to Korean Patent Application No. 2007-53372, filed on May 31, 2007, and all the benefits accruing therefrom under 35 U.S.C. §119, the contents of which in its entirety are herein incorporated by reference.

### BACKGROUND OF THE INVENTION

1. Field of the Invention

The present invention relates to an apparatus and method for setting a common voltage. More particularly, the present invention relates to an apparatus and method for setting a common voltage capable of reducing flicker due to process variations.

2. Description of the Related Art

Generally, a flicker index may be tuned in order to drive a liquid crystal display (“LCD”) device. Flicker is a phenomenon in which the intensity of light exiting from an LCD panel is not uniform and periodically varies with time so that a user observes flickering of light.

The flicker index is an important value that must be set in order to satisfy characteristic requirements for a client company, prior to a sample being delivered to the client company. A conventional flicker tuning method is performed by measuring the flicker index through a luminance detector.

That is, a developer of an LCD device adjusts a common voltage which is applied to a sample LCD panel and measures a flicker index through a luminance detector in accordance with the corresponding common voltage. Then, the developer selects an optimum flicker index of the detected flicker indexes and determines a common voltage corresponding to the optimum flicker index. Then, the determined common voltage is applied as a whole to manufactured products (e.g., the LCD device) which use the same product model as the sample LCD panel in order to perform flicker tuning.

According to the conventional flicker tuning method, even though the tested LCD panels are the same model, it is difficult to adapt to flicker characteristic variations due to different process variations for each LCD panel and variations in components of driving circuits for the different LCD panels.

### BRIEF SUMMARY OF THE INVENTION

The present invention provides an apparatus and method for setting a common voltage capable of compensating for flicker.

In one aspect of the present invention, an apparatus for setting a common voltage includes a screen generator, a flicker measuring part, a main controller and a read-only memory (“ROM”) programming part. The screen generator generates image data of a test screen. The flicker measuring part measures flicker on the test screen displayed on a display panel of a display module to which a common voltage corresponding to an estimated setting value is applied. The controller calculates a measured flicker index from the measured flicker and compares the measured flicker index with a predetermined threshold value to determine a setting value corresponding to a flicker index of a plurality of calculated flicker indexes that is less than the threshold value. The ROM programming part writes the determined setting value to a ROM of the display module.

In another aspect of the present invention, there is provided a method of setting a common voltage. In the above-mentioned method, a test screen is displayed on a display panel of a display module to which a common voltage corresponding to an estimated setting value is applied. Then, flicker on the test screen displayed on the display panel is measured. Then, a measured flicker index is calculated from the measured flicker and compared with a predetermined threshold value to determine a setting value corresponding to a flicker index of a plurality of calculated flicker indexes that is less than the threshold value. Then, the determined setting value is written to a ROM of the display module.

In still another aspect of the present invention, there is provided a method of setting a common voltage. In the above-mentioned method, a driving signal is applied in order to display a test screen on a display panel of a display module to which a common voltage corresponding to an estimated setting value is applied. Then, flicker on the test screen is measured and a measured flicker index is calculated from the measured flicker. Then, the measured flicker index is compared with a predetermined threshold value. Then, a setting value corresponding to a flicker index of a plurality of calculated flicker indexes is determined, when the measured flicker index is less than the threshold value. Then, the determined setting value is written to a ROM of the display module.

According to an apparatus and method for setting a common voltage, a setting value of a common voltage adjusted in accordance with a process variation is written to a ROM of an LCD module, so that a common voltage is reestablished by the setting value when power is applied to the LCD module so that flicker due to process variations may be prevented.

### BRIEF DESCRIPTION OF THE DRAWINGS

The above and other aspects, features and advantages of the present invention will become readily apparent by reference to the following detailed description when considered in conjunction with the accompanying drawings wherein:

FIG. 1 is a block diagram schematically illustrating an apparatus for setting a common voltage according to an exemplary embodiment of the present invention;

FIG. 2 is a block diagram schematically illustrating a driving circuit of a liquid crystal display (“LCD”) module of FIG. 1; and

FIG. 3 is a flowchart illustrating a method of driving the apparatus for setting a common voltage of FIG. 1.

### DETAILED DESCRIPTION OF THE INVENTION

The present invention is described more fully hereinafter with reference to the accompanying drawings, in which exemplary embodiments of the present invention are shown. This invention may, however, be embodied in many different forms and should not be construed as being limited to the exemplary embodiments set forth herein. Rather, these embodiments are provided so that this disclosure will be thorough and complete, and will fully convey the scope of the present invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in further detail with reference to the accompanying drawings.

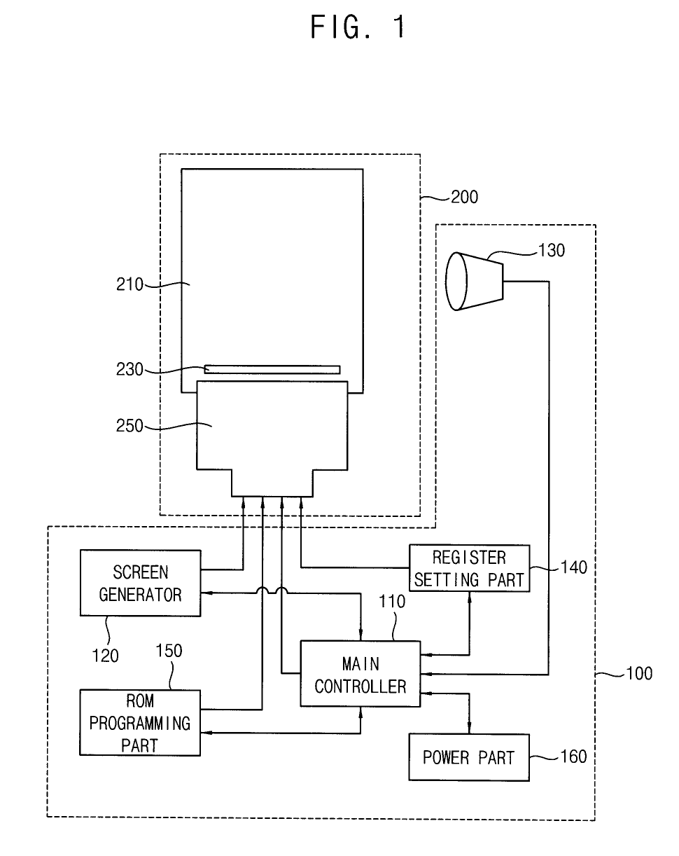

FIG. 1 is a block diagram schematically illustrating an apparatus for setting a common voltage according to an exemplary embodiment of the present invention.

Referring to FIG. 1, a common voltage generating apparatus 100 includes a main controller 110, a screen generator 120, a flicker measuring part 130, a register setting part 140, a read-only memory (“ROM”) programming part 150 and a power part 160.

The main controller 110 controls overall operation of the common voltage generating apparatus 100. The main controller 110 calculates a flicker index and determines an optimum common voltage setting value using the calculated flicker index and a predetermined threshold value. The main controller 110 may be realized by various apparatuses such as a field-programmable gate array (“FPGA”), a complex programmable logic device (“CPLD”), a microcontroller unit (“MCU”), a personal computer (“PC”), an application board, for example, but is not limited to the foregoing.

The screen generator 120 generates a test screen for detecting flicker in accordance with the control of the main controller 110 to provide the LCD module 200 with the test screen. The screen generator 120 may be realized by various apparatuses such as an FPGA, a CPLD, an MCU, a PC, an application board, for example, but is not limited to the foregoing.

The LCD module 200 includes a display panel 210, a driving circuit 230 that is mounted on the display panel 210 to output gradation data to the display panel 210, and a flexible printed circuit board (“FPCB”) 250 which connects to the driving circuit 230 and an external device (not shown). The driving circuit 230 includes a common voltage generator which provides the display panel 210 with a common voltage VCOM and a ROM (not shown) which stores a setting value for controlling the common voltage generator.

The flicker measuring part 130 measures flicker on the flicker test screen displayed on the LCD module 200 to provide the main controller 110 with the measured flicker. The main controller 110 calculates a flicker index for the test screen. The flicker measuring part 130 may be realized by various apparatuses such as an FPGA, a CPLD, an MCU, a PC, an application board, for example, but is not limited to the foregoing.

The register setting part 140 provides the common voltage generator of the LCD module 200 with a plurality of setting values which is estimated in accordance with the control of the main controller 110. The register setting part 140 may be realized by various apparatuses such as an FPGA, a CPLD, an MCU, a PC, an application board, for example, but is not limited to the foregoing.

The ROM programming part 150 writes the optimum setting value determined by the control of the main controller 110 to a ROM of the LCD module 200. The ROM programming part 150 may be realized by various apparatuses such as an FPGA, a CPLD, an MCU, a PC, an application board, for example, but is not limited to the foregoing.

The power part 160 provides the driving circuit 230 and the common voltage generating apparatus 100 with a driving voltage for driving the driving circuit 230 and the common voltage generating apparatus 100.

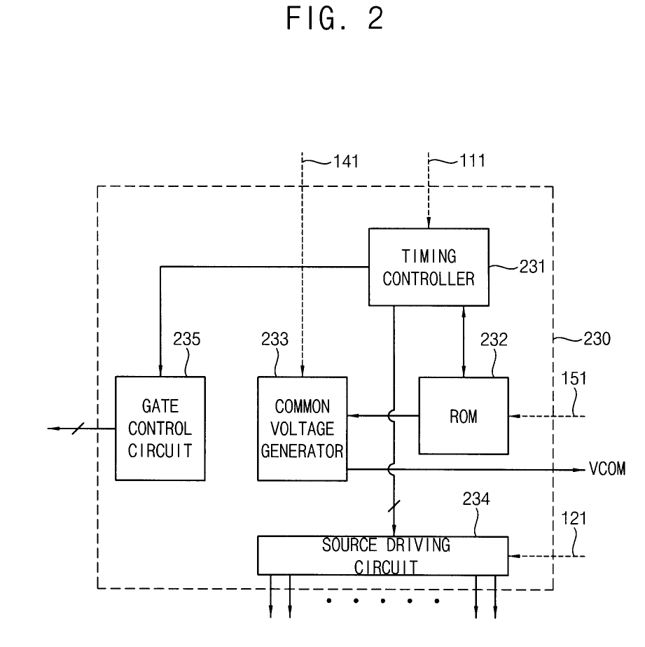

FIG. 2 is a block diagram schematically illustrating a driving circuit of the LCD module 200 of FIG. 1.

Referring to FIGS. 1 and 2, a driving circuit 230 includes a timing controller 231, a ROM 232, a common voltage generator 233, a source driving circuit 234 and a gate control circuit 235.

The timing controller 231 controls the driving timing of the driving circuit 230 based on a control signal 111 of the main controller 110.

The ROM 232 stores a setting value 151 by the ROM programming part 150. The setting value 151 corresponds to the optimum common voltage VCOM of which a flicker index, which is set by the common voltage setting apparatus 100, is minimized.

The common voltage generator 233 generates a common voltage VCOM which is provided to a common electrode (not shown) of the display panel 210. The common voltage generator 233 adjusts a level of the common voltage VCOM in correspondence with each of a plurality of estimated setting values 141 provided from the register setting part 140 to output the adjusted common voltage VCOM. Here, the setting value 141 is a variation amount of the adjusted common voltage VCOM, that is, data corresponding to an offset voltage or data corresponding to the adjusted common voltage VCOM.

The source driving circuit 234 converts image data 121 of a test screen provided from the screen generator 120 into an analog signal to output to the display panel 210.

The gate control circuit 235 outputs a gate control signal which controls the gate driving circuit (not shown) formed on the display panel 210. The gate driving circuit outputs a gate signal to the display panel 210. As a result, a test screen is displayed on the display panel 210 by the source driving circuit 234 and the gate driving circuit.

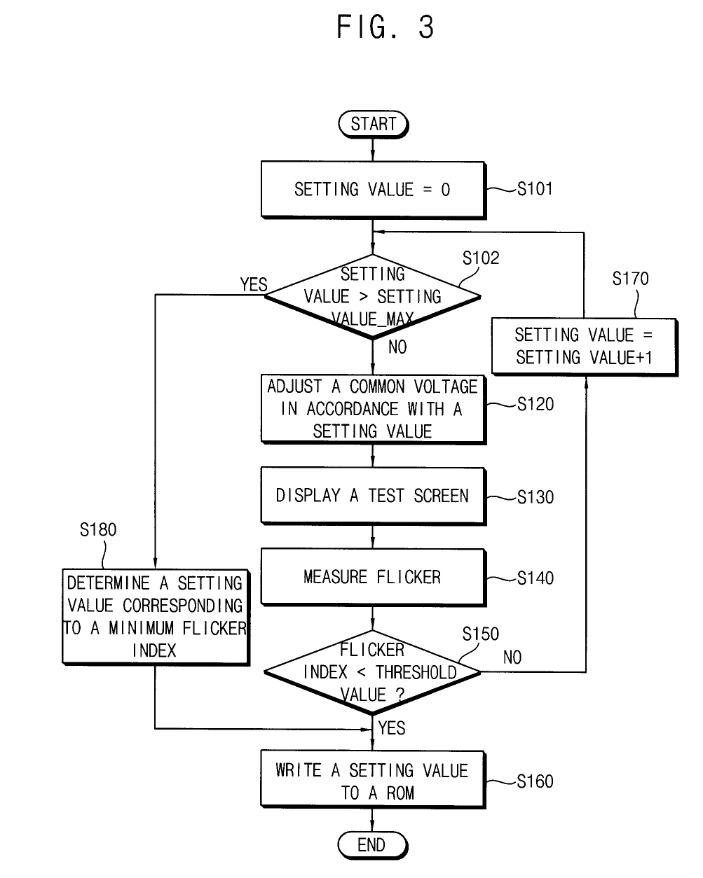

FIG. 3 is a flowchart illustrating a method of driving the apparatus 100 for setting a common voltage of FIG. 1.

Referring to FIGS. 1 to 3, the main controller 110 controls the register setting part 140 to provide the common voltage generator 233 with an estimated first setting value ‘0’. In step S101 and step S102, a process including varying a plurality of estimated setting values is described. A setting value ‘0’ denotes a first setting value of the estimated setting values, and a setting value_MAX denotes a last setting value of the estimated setting values.

The common voltage generator 233 adjusts a common voltage in accordance with the first setting value ‘0’ to provide the display panel 210 with the adjusted common voltage (step S120).

The main controller 110 controls the screen generator 120 to provide the source driving circuit 121 with image data of a test screen. Thus, the source driving circuit 234 and the gate driving circuit display the test screen on the display panel 210 (step S130).

When the test screen is displayed on the display panel 210, the flicker measuring part 130 measures flicker on the display panel 210 to provide the main controller 110 with the measured flicker (step S140). The main controller 110 calculates a flicker index to check whether the calculated flicker index is less than a predetermined threshold value (step S150).

In step S150, when the calculated flicker index is less than the threshold value, the main controller 110 controls the ROM programming part 150 to write the first setting value ‘0’ to the ROM 232 of the driving circuit 230 (step S160).

In step S150, when the calculated flicker index is greater than or equal to the threshold value, the main control part 110 controls the register setting part 140 to adjust the setting value into a second setting value ‘1’ (step S170).

The register setting part 140 provides the common voltage generator 233 with the setting value ‘1’, and adjusts a common voltage in accordance with the second setting value ‘1’ to provide the display panel 210 with the adjusted common voltage (step S120). Then, steps S130, S140 and S150 are repeatedly performed.

As a result, each flicker index for the estimated setting values is calculated, and then the calculated flicker index is compared with the threshold value. Then, a setting value having a flicker index that is less than the threshold value is determined as the optimum setting value, so that the optimum setting value is written to the ROM 232.

When the calculated flicker indexes for the estimated setting values are greater than or equal to the threshold value, a setting value corresponding to the minimum flicker index of the calculated flicker indexes is determined as an optimum setting value (step S180). Then, the determined setting value is written to the ROM 232.

The setting value having the minimum flicker index is written to the ROM 232 of the LCD module 200, so that the setting value which is stored in the ROM 232 controls the common voltage generator 233 to adjust a level of a common voltage when the LCD module 200 is booted.

Therefore, the LCD module is set to be provided a common voltage level of which a flicker index is a minimum value, so that flicker due to process variations may be minimized.

As described above, according to the present invention, flicker according to driving variations, process variations, etc., of corresponding display panels may be minimized. Therefore, the reliability of flicker tuning may be enhanced, and display quality may also be enhanced.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An apparatus for setting a common voltage, the apparatus comprising:
a screen generator which generates image data of a test screen;
a flicker measuring part which measures a flicker index on the test screen displayed on a display panel of a display module to which a common voltage corresponding to an estimated setting value is applied;
a main controller which calculates a measured flicker index from the measured flicker and compares the measured flicker index with a predetermined threshold value to determine a setting value corresponding to a flicker index of a plurality of calculated flicker indexes that is less than the threshold value; and
a read-only memory (ROM) programming part which writes the determined setting value to a ROM of the display module.

2. The apparatus of claim 1, further comprising:
a register setting part which provides a common voltage generator of the display module with the estimated setting value.

3. The apparatus of claim 1, wherein
the main controller predicts a plurality of setting values, and
the main controller determines a setting value corresponding to a minimum flicker index of the plurality of calculated flicker indexes when all of the flicker indexes are greater than or equal to the threshold value.

4. A method of setting a common voltage, the method comprising:
displaying a test screen on a display panel of a display module to which a common voltage corresponding to an estimated setting value is applied;
measuring flicker on the test screen displayed on the display panel;
calculating a measured flicker index from the measured flicker;
comparing the measured flicker index with a predetermined threshold value to determine a setting value corresponding to a flicker index of a plurality of calculated flicker indexes that is less than the threshold value; and
writing the determined setting value to a ROM of the display module.

5. The method of claim 4, further comprising:
providing a common voltage generator of the display module with the estimated setting value; and
applying an adjusted common voltage corresponding to the estimated setting value to the display panel.

6. The method of claim 4, further comprising determining a setting value corresponding to a minimum flicker index of the plurality of calculated flicker indexes, when all of the calculated flicker indexes corresponding to respective estimated setting values are greater than the threshold value.

7. The method of claim 6, wherein a setting value corresponding to the minimum flicker index is written to the ROM of the display module.

8. A method of setting a common voltage, the method comprising:
applying a driving signal in order to display a test screen on a display panel of a display module to which a common voltage corresponding to an estimated setting value is applied;
measuring flicker on the test screen;
calculating a measured flicker index from the measured flicker;
comparing the measured flicker index with a predetermined threshold value;
determining a setting value corresponding to a flicker index of a plurality of calculated flicker indexes, when the measured flicker index is less than the threshold value; and
writing the determined setting value to a ROM of the display module.

9. The method of claim 8, further comprising:
increasing the setting value, when the measured flicker index is greater than or equal to the threshold value; and
applying a driving signal in order to display a test screen on the display panel of the display module to which a common voltage corresponding to the increased setting value is applied, and feeding back to the step of the measuring the flicker index on the test screen.

10. The method of claim 8, wherein applying a driving signal in order to display the test screen on the display panel of the display module to which a common voltage corresponding to the estimated setting value is applied comprises:
setting a first setting value of a plurality of estimated setting values;
checking whether the first setting value is greater than a last setting value of the estimated setting values or not;
determining a setting value corresponding to a minimum flicker index of the plurality of calculated flicker indexes, when the first setting value is greater than the last setting value, and feeding back to the step of writing the determined setting value to the ROM of the display module;
adjusting a common voltage in accordance with the first setting value, when the first setting value is greater than or equal to the last setting value; and
applying the driving signal in order to display the test screen on the display panel by using the adjusted common voltage.
